(19) United States
(12) Patent Application Publication
(10) Pub. No.: US 2014/0124461 A1
(43) Pub. Date: May 8, 2014

(54) Process for Inhibiting Biological Growth On a Gravity Fed Disc Filter

(71) Applicant: VEOLIA WATER SOLUTIONS & TECHNOLOGIE, Saint-Maurice (FR)

(72) Inventors: Herve Buisson, Apex, NC (US); Pille Kangsepp, Malmo (SE); Rune Strube, Rungsted Kyst (DK); Janne Olavi Vaananen, Barseback (SE)

(73) Assignee: VEOLIA WATER SOLUTIONS & TECHNOLOGIES SUPPORT, Saint-Maurice (FR)

(21) Appl. No.: 13/671,068

(22) Filed: Nov. 7, 2012

(51) Int. Cl. B01D 33/50; B01D 33/21; B01D 33/72; B01D 33/80

(52) U.S. Cl. CPC B01D 33/50; B01D 33/804; B01D 33/21; B01D 33/807; B01D 33/72
USPC 210/780; 210/393; 210/139; 210/107

(57) ABSTRACT

A rotary disc filter is provided with a system for inhibiting biological fouling from biological growth on filters that form a part of the rotary disc filter. A biocide is pumped from a biocide supply tank to a manifold and mixed with a backwash to form a backwash-biocide solution. The backwash-biocide solution is sprayed onto filter media during a backwashing operation and the presence of the biocide inhibits and eliminates biological growth on the filter media.

### FIELD OF THE INVENTION

The present invention relates to rotary disc filters for treating wastewater, and more particularly to a method for inhibiting biological growth on filtration media employed in rotary disc filters.

### BACKGROUND

Biofouling from biological growth on filter media is a serious problem in water treatment facilities, and, in particular, filters used therein. This biological growth is usually present in the form of biofilm. Biofilm comprises bacterial colonies that attach to filter media and the excretions therefrom. Biofilm clogs and fouls filters and, without treatment, can result in total filter blockage within a period of days or weeks.

These problems are only exacerbated when filter media is comprised of nonwoven media. Such nonwoven media can be produced with openings smaller than ten microns, and may be used in rotary disc filters to improve removal efficiency and filtration rates. These filtration improvements from nonwoven filter media, however, cannot be maintained due to the formation of biofilm on the fibers comprising the nonwoven filter media. Such biofilm cannot be eliminated with a standard 8 bar backwash typically used in disc filter backwashing operations. Indeed, backwash up to 80 bar is insufficient to eliminate such biofouling. After approximately one to two weeks of utilization for tertiary water treatment, in many cases nonwoven filter media will be completely blocked by biofouling.

### SUMMARY OF THE INVENTION

Disclosed herein is a method or process for inhibiting bio-fouling from biological growth on filtration media of a rotary disc filter. In this method, water is directed to the rotary disc filter comprising at least one filter disc. The filter disc has filter media positioned to permit water filtration. The water is directed through the filter media to produce a filtrate. The filter media is then positioned for cleaning by rotating at least a portion of the filter media to a backwashing position. A backwash is provided and a biocide is mixed therewith to produce a backwash-biocide solution. The backwash-biocide solution is then sprayed onto the filter media during a backwashing operation, and inhibits and eliminates biological growth on the filter media.

### DESCRIPTION OF THE DRAWINGS

FIG. 1 is a perspective view of an exemplary disc filter with portions of the structure broken away to better illustrate basic components of the disc filter.

FIG. 1A is a schematic illustration of an end view of the disc filter showing the backwash pump and the drive system for driving the drum and filter disc.

FIG. 2 is an illustration of one embodiment of the backwash manifold and biocide supply.

FIG. 3 is an illustration of another embodiment of the backwash manifold and biocide supply.

FIG. 4 is a schematic illustration showing an alternative embodiment where the biocide is sprayed directly onto the filter media of respective disc shaped filter members.

### DETAILED DESCRIPTION

The current invention is directed towards methods for inhibiting biological growth on rotary disc filters. Rotary disc filters are well known and widely used to provide water filtration. As used herein, the term ‘water’ encompasses all forms of feedwater, to include wastewater. Rotary disc filters are shown and described in patents and other published materials. For example, reference is made to U.S. Pat. No. No. 7,597,805 and U.S. Patent Publication No. 2008/0035584. The disclosures of these two publications are expressly incorporated herein by reference. A complete and unified understanding of disc filters, their structure, and operation can be gained by reviewing these materials.

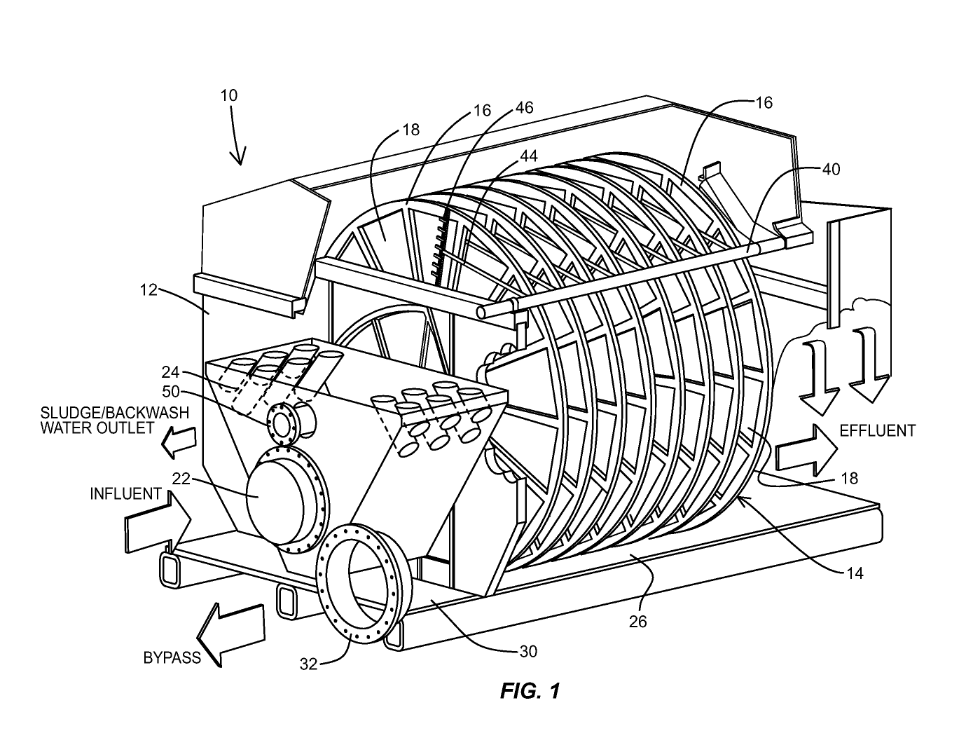

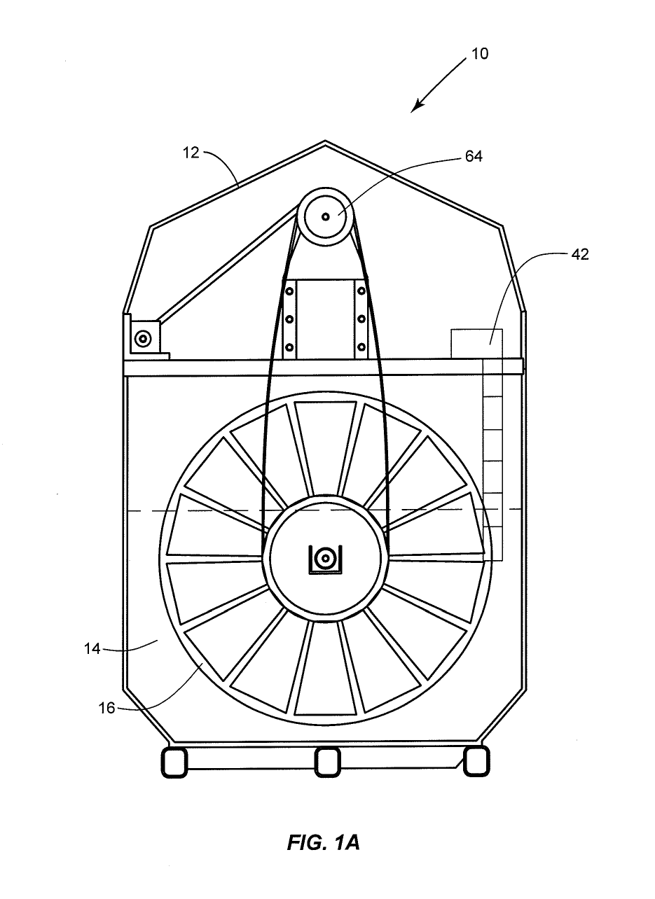

A brief overview of the structure and operation of a typical disc filter may be beneficial. FIG. 1 shows a disc filter indicated generally by the numeral 10. Disc filter 10 includes an outer housing 12 or an open frame structure for installation in channels. Rotatively mounted in the housing 12 is a drum. Generally, the drum is enclosed, except that it includes an inlet opening and a series of openings formed in the surface thereof for enabling influent to flow from the drum into a series of rotary filter disc, indicated generally by the numeral 14, mounted on the drum. That is, as will be appreciated from subsequent discussions herein, influent is directed into the drum, and from the drum through openings in the surface thereof into the respective rotary filter discs 14.

The number of rotary filter discs 14 secured on the drum and rotatable therewith can vary. Basically, each rotary filter disc 14 includes a filter frame 16 and filter media 18 secured on opposite sides of each rotary filter disc 14. A holding area is defined inside each rotary filter disc 14 for receiving influent to be filtered by the rotary filter disc 14.

The disc filter 10 is provided with a drive system for rotatively driving the drum and the rotary filter discs 14 mounted thereon. There is provided a drum motor 64 that is operative to drive a sprocket or sheave (not shown) connected to the drum. See FIG. 1A. Various means can be operatively interconnected between the drum motor 64 and the sprocket for driving the sprocket, and hence the drum. For example, a belt drive can be utilized. Various other types of drive systems can be utilized to rotate the drum and the rotary filter discs 14 mounted thereon.

Continuing to refer to FIG. 1, the disc filter 10 includes an influent inlet 22. Influent inlet 22 leads to an influent holding tank 24. Influent holding tank 24 is disposed adjacent an inlet opening formed in the drum such that influent held within the influent holding tank 24 can flow from the holding tank into the drum. As seen in the drawings, the influent holding tank is disposed on the upstream side of the disc filter 10. Disposed around and generally below the influent holding tank 24 is a bypass tank 30. An outlet 32 enables influent to flow from the bypass tank 30. Note that the influent holding tank 24 includes overflow openings. These overflow openings permit influent overflow to flow from the influent holding tank 24 downwardly into the bypass tank 30. This effectively limits the water level height in the influent holding tank 24.

Disc filter 10 also includes an effluent holding tank 26. Effluent holding tank 26 is disposed about a downstream end portion of the disc filter 10, and as shown in the drawings, extends around at least a lower portion of the rotary filter discs 14. As the influent moves outwardly through the filter media 18, this results in the water being filtered, and it follows that the filtered water constitutes an effluent. It is this effluent that is held within the effluent holding tank 26. There is also provided an effluent outlet associated with the effluent holding tank 26 for directing effluent or filtered water from the disc filter 10.

Therefore, it follows that influent water to be treated or filtered is directed into the influent inlet 22 and into the influent holding tank 24 where the water accumulates to a selected height therein so as to provide a head pressure for effectively causing the water to move from the inner portions of the rotary filter discs 14 outwardly through the filter media 18. Influent held within the holding tank 24 eventually is directed into the drum, and from the drum through openings therein into the interior areas of the rotary filter discs 14. Now, the water within the rotary filter disc moves outwardly through the filter media 18 into the effluent holding tank 26, and eventually out the effluent outlet.

The present application focuses on methods for preventing biological growth on disc filters. One way to prevent, eliminate, or inhibit biological growth is to utilize a biocide. Biocides are substances (or in some cases organisms) that kill currently growing biological contaminants and deter growth of new biological contaminants. For example, the biocide chlorine has long been added to swimming pools and spas to both kill bacteria present in the pool water and prevent new bacterial growth therein.

The methods disclosed herein may be used with any biocide that can remove biofilm from filter media. In preferred embodiments, the biocide is one that does not cause environmental harm. One preferred type of biocide is peroxy acids. One example of a peroxy acid is peracetic acid. Peracetic acid inhibits growth of a broad range of biological contaminants. After treatment, peracetic acid breaks down into hydrogen peroxide and acetic acid, which are non-toxic and environmentally friendly. In one exemplary embodiment, the concentration of the peracetic acid used is approximately 2-15% by weight. Another example of a peroxy acid (biocide) is performic acid. Performic acid effectively inhibits growth of, inter alia, bacteria, fungi, viruses, and other microorganisms. Because performic acid degrades to carbon dioxide, oxygen, and water, it is an environmentally friendly biocide.

The present invention envisions incorporating a biocide application into the backwashing system of a rotary disc filter. One such backwashing system is shown in FIGS. 1 and 1A. Generally the backwashing system includes a manifold 40 that extends along a side of the disc filter 10 and is operatively connected to a backwash pump 42 that is operative to direct high pressure wash water (usually filtrate produced by the disc filter) through the manifold 40. Extending off the manifold 40 are a series of feed pipes 44 with each feed pipe being connected at its outer end to a nozzle array 46. As seen in the drawings there is a sludge or backwash water outlet 50. Outlet 50 is operatively connected to a trough or a catch structure that extends through the drum and is disposed generally underneath the various nozzle arrays 46. When the backwashing system is in operation, the debris, sludge and wash water fall into the trough or catch structure and through gravity pass from the disc filter 10 through the sludge or backwash water outlet 50.

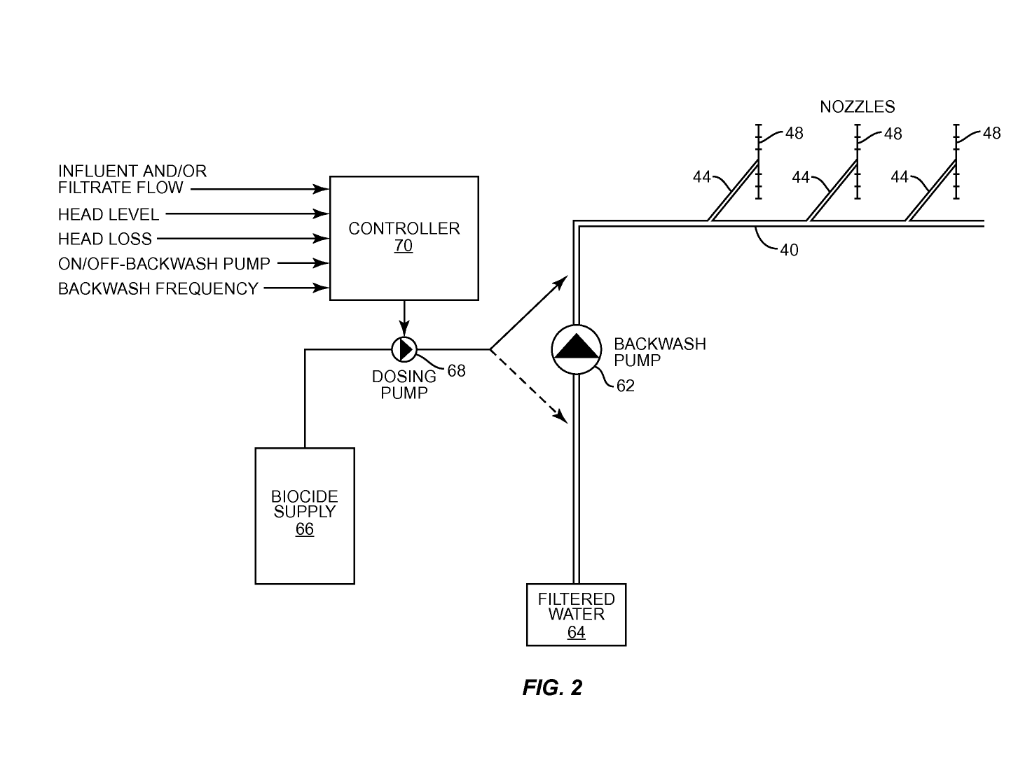

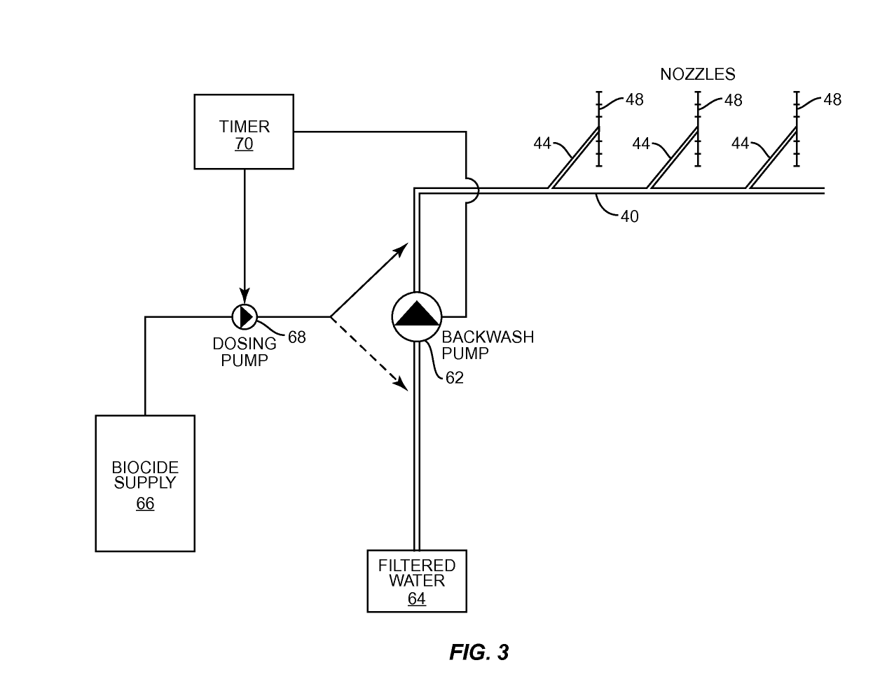

As shown in FIGS. 2-3, manifold 40 is operatively connected to a backwash pump 62, which in turn is operatively connected to a backwash supply 64. As alluded to above, in many instances the backwash system will utilize the filtered water produced by the disc filter as the backwash. As seen in FIG. 2, for example, the dosing pump 68 is operatively connected to the biocide supply 66 which typically includes one or more tanks for supplying the selected biocide such as peracetic acid (performic acide which can be produced on site). Some biocides, for example performic acid (the biocide), can be produced on site and supplied to the dosing pump 68. The dosing pump 68 includes an outlet that is operatively connected to the manifold 40 of the backwash system. As seen in FIG. 2, the biocide pumped from the dosing pump 68 can be directed into the manifold 40 either upstream or downstream of the backwash pump 62. It is believed generally that it is preferable for the biocide to be injected into the manifold 40 downstream of the backwash pump 62. However, in tank versions of the disc filter, it may be possible to inject the biocide on the suction side (i.e., upstream side) of the backwash pump 62. This may have the extra benefit of cleaning the backwash pump 62. In some embodiments, a controller 70 is used to regulate biocide dosing. One of skill in the art appreciates that many types of controllers may be utilized, to include timers, PLCs, and computer-based systems (which may include remote and wireless control features). In one embodiment, shown in FIG. 2, controller 70 is a PLC. In this embodiment, controller 70 may consider one or a combination of factors to control the frequency and amount of doses. Examples of such factors include, but are not limited to, filtrate flow, influent flow, backwash frequency, head level, and head loss (the difference between the height of the influent head and the height of the filtrate level). One of skill in the art is aware of numerous other factors that could also be used. In one embodiment, shown in FIG. 3, controller 70 is a timer. In this case, the timer is set or programmed to permit dosing of the biocide into the backwash at selected times and for selected time periods. In this embodiment, backwash pump 62 is configured to communicate with the timer, such that the timer only permits dosing from dosing pump 68 when backwash pump 62 is at the on position.

In one embodiment, the biocide is dosed to the backwash at a concentration of approximately 10-300 ppm, with dosing occurring approximately 5-100% of the time. The concentration of the biocide dosed and the frequency of dosing will vary depending upon conditions and particular application. In one embodiment, for example, it is believed that in many applications a concentration of approximately 20-80 ppm of biocide with a dosing frequency of 10-20% will be sufficient to control biofouling on the filter media. The term “frequency of dosing” is a term that compares the frequency of applying the biocide relative to the frequency of backwashing. For example, a dosing frequency of 50% means that the biocide is being mixed with the backwash one-half or 50% of the time. In order to backwash the filter media 18, the drum can be continuously or intermittently rotated such that the filter media or filter panels 18 enter the accumulated effluent in the effluent holding tank 26. It is appreciated that only a bottom portion of the filter media 18 is effective at any one time to filter the influent. From time-to-time the drum and rotary filter discs 14 will be rotated, and when this occurs, some portions of the filter media 18 will be rotated to an upper portion and in this position the filter media 18 will not be in a position to filter the effluent.

During a backwash cycle, high pressure backwash-biocide solution is sprayed from the nozzle arrays 46 onto the outer surfaces of the filter media 18 to clean them. This can occur when the drum and rotary filter discs 14 are stationary or being rotated. The backwash-biocide solution sprayed on from the nozzle arrays 46 impacts the outer surface of the filter media 18, vibrating the filter media and even penetrating the filter media. This causes debris caught on the inner side of the filter media 18 to be dislodged or removed from the inner surface of the filter media 18. This debris and the backwash water fall into the underlying trough extending through the drum. Thereafter the debris and backwash water are channeled out the outlet 50. It is appreciated that, while upper portions of the filter media 18 are backwashed, disinfected, and cleaned, the lower submerged portions of the filter media can continue to filter the influent.

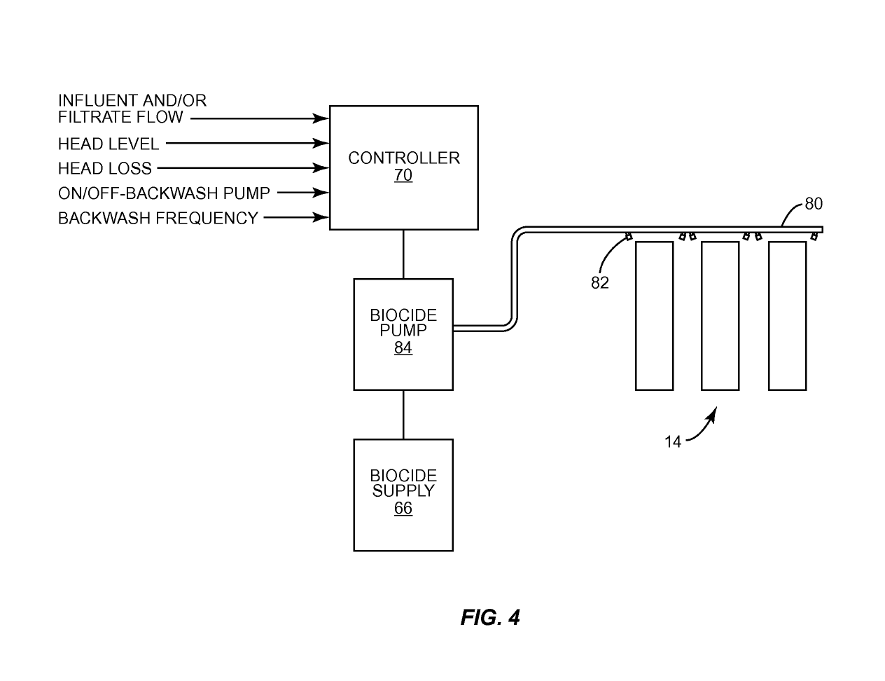

In another embodiment, the biocide could be applied to the filter media independently of the backwash system. In this case, a separate set of nozzles could be utilized to spray the biocide onto the filter media. The biocide could be chemically diluted and applied at a relatively low pressure, for example, 1-2 bar, while the filter discs are rotated relatively slowly. An example of this embodiment is shown in FIG. 4. In the FIG. 4 embodiment, the biocide pump 84 is operatively connected to a manifold 80 that includes a plurality of nozzles 82. The nozzles 82 are spaced such that one or more nozzles is directed to each side of each disc-shaped filter member 14. Biocide pump 84 is operatively connected to a biocide supply 66 which could be a biocide tank or a system for producing biocide on site. Biocide pump 84 is controlled by a controller 70 or, as discussed above, a timer or other type of control system. In this case, from time-to-time, the biocide will be sprayed onto the filter media of the disc filters 14 to control or inhibit biofouling. In this embodiment, biocide is pumped from the biocide supply to the biocide pump 84 and then directed into the manifold 80. Thereafter, the biocide is sprayed under pressure onto the filter media of the individual disc-shaped filter members.

Although the present methods have been shown and described in considerable detail with respect to only a few/particular exemplary embodiments thereof, it should be understood by those skilled in the art that it is not intended to limit the methods to the embodiments since various modifications, omissions, and additions may be made to the disclosed embodiments without materially departing from the novel teachings and advantages of the methods, particularly in light of the foregoing teachings.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

1-6. (canceled)

7. A method of filtering water with a rotary disc filter and inhibiting biofouling of non-woven filter media, the method comprising:
directing water into one or more rotary filter discs that form a part of the rotary disc filter;
directing the water through non-woven filter media positioned on opposite sides of the rotary filter discs to produce a filtrate;
rotating the rotary filter disc such that a portion of the non-woven filter media is moved from a submerged position in the filtrate to an upper cleaning position where the portion of the non-woven filter media lies above the filtrate; and
controlling biofouling on the non-woven filter media by spraying a biocide onto an exterior surface of the non-woven filter media when the non-woven filter media lies above the filtered water.

8. The method of claim 7 including pumping the biocide from a biocide supply into a backwash system where the biocide is mixed with the backwash to form a backwash-biocide solution.

9. The method of claim 8 wherein the biocide concentration in the backwash-biocide solution is about 10 to about 300 ppm.

10. The method of claim 7 including:
pumping a biocide from a biocide holding tank;
pumping a backwash from a backwash supply;
mixing the biocide with the backwash to form a backwash-biocide solution; and
spraying the backwash-biocide solution onto the non-woven filter media to control biofouling.

11. The method of claim 7 wherein the rotary disc filter includes two separate sets of nozzles, one set of nozzles configured to spray a biocide solution onto the non-woven filter media and a second set of nozzles configured to spray a backwash onto the non-woven filter media; and wherein the method entails pumping a biocide solution to the first set of nozzles and spraying the biocide solution onto the exterior surfaces of the non-woven filter media lying above the filtrate; and simultaneously or non-simultaneously with the spraying of the biocide, spraying the backwash onto the exterior surfaces of the non-woven filter media lying above the filtrate.

12-14. (canceled)

15. A method of filtering water with a rotary disc filter and inhibiting biofouling of a woven filter media, the method comprising:
directing water into one or more rotary filter discs that forms a part of the rotary disc filter;
directing the water through the woven filter media positioned on opposite sides of the rotary filter disc to produce a filtrate;
rotating the rotary filter disc such that a portion of the woven filter media is moved from a submerged position in the filtrate to an upper cleaning position where the portion of the woven filter media lies above the filtrate; and
controlling biofouling on the woven filter media by spraying a biocide onto the exterior surface of the woven filter media when the woven filter media lies above the filtered water.

16. The method of claim 15 including pumping the biocide from a biocide supply into a backwash where the biocide is mixed with the backwash to form a backwash-biocide solution, and thereafter spraying the backwash-biocide solution onto the woven filter media.

17. The method of claim 16 wherein the biocide concentration in the backwash-biocide solution is about 10 to about 300 ppm.

18. The method of claim 15 including:
pumping a biocide from a biocide holding tank;
pumping a backwash from a backwash supply;
mixing the biocide with the backwash to form a backwash-biocide solution; and
spraying the backwash-biocide solution onto the woven filter media to control biofouling.

19. The method of claim 15 wherein the rotary disc filter includes two separate sets of nozzles, one set of nozzles configured to spray a biocide solution onto the woven filter media and a second set of nozzles configured to spray a backwash onto the woven filter media;
wherein the method entails pumping a biocide solution to the first set of nozzles and spraying the biocide solution onto the exterior surfaces of the woven filter media lying above the filtrate;
and simultaneously or non-simultaneously with the spraying of biocide, spraying the backwash onto the exterior surfaces of the woven filter media lying above the filtrate.

20. The method of claim 15 wherein the biocide is selected from the group of peroxy acids comprising: peracetic acid and performic acid.
